(19) United States
(12) Patent Application Publication
(10) Pub. No.: US 2013/0035993 A1
(43) Pub. Date: Feb. 7, 2013

(54) METHODS AND SYSTEMS FOR ONLINE QUOTING

(71) Applicant: Yuliya Hungate, Reno, NV (US)

(72) Inventor: Yuliya Hungate, Reno, NV (US)

(21) Appl. No.: 13/565,812

(22) Filed: Aug. 3, 2012

Related U.S. Application Data
(60) Provisional application No. 61/514,481, filed on Aug. 3, 2011.

(51) Int. Cl. G06Q 30/02

(52) U.S. Cl. 705/14.1; 705/26.4

(57) ABSTRACT

Methods and systems for online quoting are disclosed. The method may include receiving a user request for price quotes for services. Based on the use request, service providers associated with the services may be selected, and the price quotes may be calculated based on predetermined parameters of the service providers. When calculated, the price quotes may be provided to the user.

### CROSS-REFERENCE TO RELATED APPLICATIONS

This application claims priority of U.S. Provisional Application No. 61/514,481, entitled “METHODS AND SYSTEMS FOR ONLINE QUOTING,” filed Aug. 3, 2011, which is incorporated herein by reference in its entirety for all purposes.

### FIELD

This disclosure relates generally to methods and systems for facilitating buyer and seller interactions, and more particularly to instant price quoting for online products or services based on user input.

### BACKGROUND

The approaches described in this section could be pursued but are not necessarily approaches that have been previously conceived or pursued. Therefore, unless otherwise indicated, it should not be assumed that any of the approaches described in this section qualify as prior art merely by virtue of their inclusion in this section.

The Internet is widely used by merchants to advertise their products and services. Merchants may use websites or other online tools to advertise their products. There are numerous online stores selling goods and simple packaged services online. However, providing a custom estimate based on specific requirements is difficult and requires human involvement. Typically, when complex services are requested, a customer may browses Internet and contact a service provider to get a price estimate, turnaround time, service details, geographical location of the service provider, and so forth. Typically, the customer contacts multiple service providers to get a good understanding of the market. Thus, before making a purchase decision, the customer may engages in a time-consuming process requiring considerable amount of time to make calls, send e-mails, and collect information.

Additionally, many minor service providers have non-informative websites for advertisement of their services. Besides, many service providers do not have any online price-estimating tools allowing them to provide an estimate of a price and turnaround time for their services.

### SUMMARY

This summary is provided to introduce a selection of concepts in a simplified form that are further described below in the Detailed Description. This summary is not intended to identify key features or essential features of the claimed subject matter, nor is it intended to be used as an aid in determining the scope of the claimed subject matter.

Provided are methods and systems for online quoting. In general, these methods and systems may allow obtaining an instant estimate of a price, turnaround time, and other information related to services.

A method for providing one or more price quotes may include receiving a user request for a price quote from a user. The user request may be associated with a number of services. Based on the user request, service providers associated with the services may be selected. Then, price quotes for the selected service providers may be calculated based on user data and predetermined settings of the service providers. The resulting price quotes may be provided to the user.

### BRIEF DESCRIPTION OF THE DRAWINGS

Embodiments are illustrated by way of example and not limitation in the figures of the accompanying drawings, in which like references indicate similar elements and in which:

FIG. 1 shows a block diagram illustrating a system environment suitable for online quoting of services provided by service providers, in accordance with an example embodiment.

FIG. 2 is a diagram of a quoting system, in accordance with an example embodiment.

FIG. 3 is a process flow diagram showing a method for providing a price quote, in accordance with an example embodiment.

FIG. 4 is a process flow diagram showing a method for providing a price quote, in accordance with an example embodiment.

FIG. 5 illustrates a graphical user interface for making a user request for a service, in accordance with an example embodiment.

FIG. 6 illustrates a graphical user interface showing a generated list of price quotes responsive to a user request, in accordance with an example embodiment.

FIG. 7 is a diagrammatic representation of an example machine in the form of a computer system within which a set of instructions for causing the machine to perform any one or more of the methodologies discussed herein is executed, in accordance with an example embodiment.

### DETAILED DESCRIPTION

The following detailed description includes references to the accompanying drawings, which form a part of the detailed description. The drawings show illustrations in accordance with example embodiments. These example embodiments, which are also referred to herein as “examples” are described in enough detail to enable those skilled in the art to practice the present subject matter. The embodiments may be combined, other embodiments may be utilized, or structural, logical and electrical changes may be made without departing from the scope of what is claimed. The following detailed description is, therefore, not to be taken in a limiting sense, and the scope is defined by the appended claims and their equivalents.

In this document, the terms “a” or “an” are used, as is common in patent documents, to include one or more than one. In this document, the term “or” is used to refer to a nonexclusive “or”, such that “A or B” includes “A but not B”, “B but not A”, and “A and B”, unless otherwise indicated. Furthermore, all publications, patents, and patent documents referred to in this document are incorporated by reference herein in their entirety, as though individually incorporated by reference. In the event of inconsistent usages between this document and those documents so incorporated by reference, the usage in the incorporated reference(s) should be considered supplementary to that of this document; for irreconcilable inconsistencies, the usage in this document controls.

The embodiments described herein may be implemented by various means, depending on application. For example, the embodiments may be implemented in hardware, firmware, software, or a combination thereof. For hardware implementation, the embodiments may be implemented with processors, controllers, micro-controllers, microprocessors, electronic devices, other electronic units designed to perform the functions described herein, or a combination thereof. Memory may be implemented within a processor or external to the processor. As used herein, the term “memory” refers to any type of long term, short term, volatile, nonvolatile, or other storage device and is not to be limited to any particular type of memory or number of memories, or type of media upon which memory is stored. For firmware and/or software implementation, the embodiments may be implemented with modules such as procedures, functions, and so on, that perform the functions described herein. Any machine readable medium tangibly embodying instructions may be used in implementing the embodiments described herein.

The embodiments disclosed herein relate to methods and systems for online estimates of service prices, turnaround times, and other commercial related information.

In some example embodiments, the methods and systems for online quoting disclosed herein may include a server having a database, which provides instant quotes to users responsive to their input. The quotes may be delivered via a network, such as the Internet, and may be displayed by client devices, such as computers, mobile devices, smart phones, PDA, or the like. To generate a quote for the services requested by a user, the server may retrieve certain predetermined parameters associated with service providers.

The quote generated responsive to the user request may include such information as estimated prices of one or more service providers, estimated turnaround time, a geographical location and proximity to the user, discount details, service description, ranks of the service providers, and so forth. In some example embodiments, the generated quotes may be filtered or sorted based on certain predetermined settings. For example, the quotes may be sorted as to show only nearby service providers or the service providers having higher ranks. Once the quotes are generated and provided to the client device, the user may select one or more quotes to order services or contact certain service providers and negotiate details.

In some example embodiments, the methods and systems for online quotes provide users with functionality to post information, submit reviews of the ordered services, rank service providers, review profiles of the service providers, and so forth. The service providers may be provided with a functionality to establish and manage profiles, establish a list of services and prices related to the services, establish discount algorithms, monitor traffic associated with their profiles or web pages, bid on a higher “best match” position in the quote provided to the users, and so forth.

The term “user” (or “prospect”, “consumer”, “customer”), as used herein, relates to a user of a client device. The user is to receive an estimate of price, turnaround time, locations of service providers, and other service related information.

The term “service provider” is used herein to refer to a merchant, seller, retailer, distributor, trader, and the like. It will be understood that service providers may provide products or services online or at “brick and mortar” establishments such as stores, shops, malls, restaurants, cafes, hotels, rental offices, transport companies, and the like.

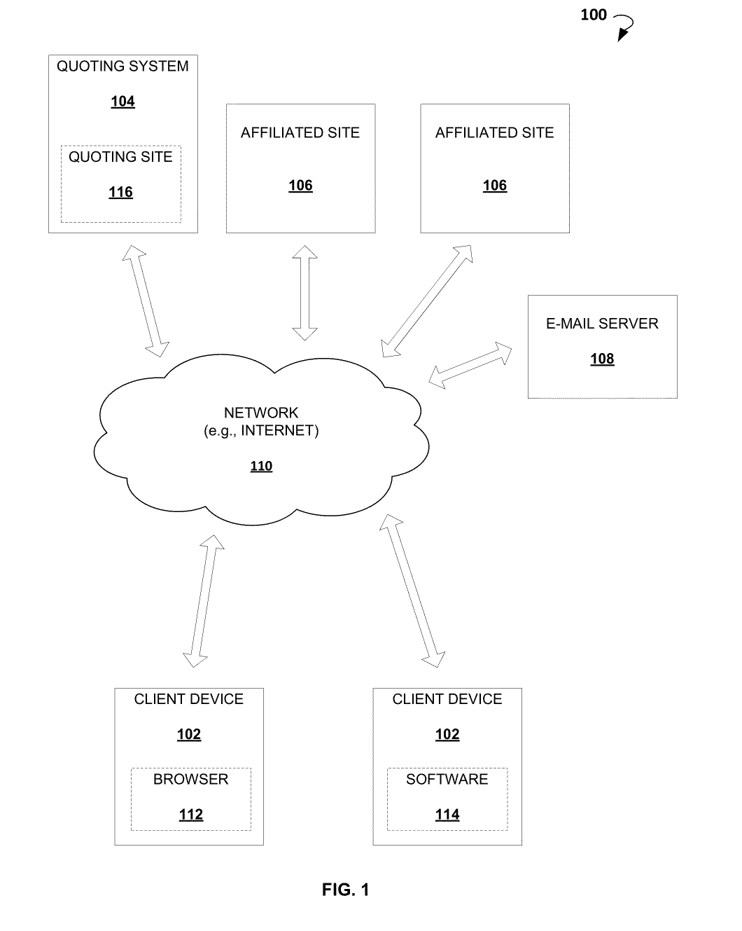

Referring now to the drawings now, FIG. 1 shows a block diagram illustrating a system environment 100 suitable for online quoting of services provided by service providers, according to an example embodiment. The system environment 100 includes one or more client devices 102, a quoting system 104, one or more affiliated sites 106, one or more e-mail servers 108, and a network 110. The network 110 may couple one or more of the aforementioned modules.

The network 110 is a network of data processing nodes interconnected for the purpose of data communication, which may be utilized to communicatively couple various components of the environment 100. The network 110 may include the Internet or any other network capable of communicating data between devices. Suitable networks may include or interface with any one or more of, for instance, a local intranet, a PAN (Personal Area Network), a LAN (Local Area Network), a WAN (Wide Area Network), a MAN (Metropolitan Area Network), a virtual private network (VPN), a storage area network (SAN), a frame relay connection, an Advanced Intelligent Network (AIN) connection, a synchronous optical network (SONET) connection, a digital T1, T3, E1 or E3 line, Digital Data Service (DDS) connection, DSL (Digital Subscriber Line) connection, an Ethernet connection, an ISDN (Integrated Services Digital Network) line, a dial-up port, such as a V.90, V.34 or V.34b is analog modem connection, a cable modem, an ATM (Asynchronous Transfer Mode) connection, or an FDDI (Fiber Distributed Data Interface) or CDDI (Copper Distributed Data Interface) connection. Furthermore, communications may also include links to any of a variety of wireless networks, including WAP (Wireless Application Protocol), GPRS (General Packet Radio Service), GSM (Global System for Mobile Communication), CDMA (Code Division Multiple Access) or TDMA (Time Division Multiple Access), cellular phone networks, GPS (Global Positioning System), CDPD (cellular digital packet data), RIM (Research in Motion, Limited) duplex paging network, Bluetooth radio, or an IEEE 802.11-based radio frequency network. The network 120 may further include or interface with any one or more of an RS-232 serial connection, an IEEE-1394 (Firewire) connection, a Fiber Channel connection, an IrDA (infrared) port, a SCSI (Small Computer Systems Interface) connection, a USB (Universal Serial Bus) connection or other wired or wireless, digital or analog interface or connection, mesh or Digi® networking.

As used herein, the term “client device” refers to a computer, a laptop, a tablet computer, a portable computing device, a personal digital assistant (PDA), a handheld cellular phone, a mobile phone, a smart phone, a wireless telephone, a handheld device having wireless connection capability, or any other electronic device with the ability to receive and transmit data via a wire or wireless network (e.g., with the ability to browse the Internet). The client devices 102 may also be configured to determine its geographical location based on GPS signals, IP address, base station information, and so forth.

The client devices 102 may be used to get instant quotes for services, and may be used by service providers to establish and manage their profiles, list services they may provide and to list the prices for the services.

In some embodiments, the client devices 102 may include a browser 112 providing the ability to browse and interact with sites on the Internet. In some other embodiments, the client devices 102 may include software 114 to communicate with the quoting system 104. In one example, the software 114 is a mobile application embedded in the client device 102.

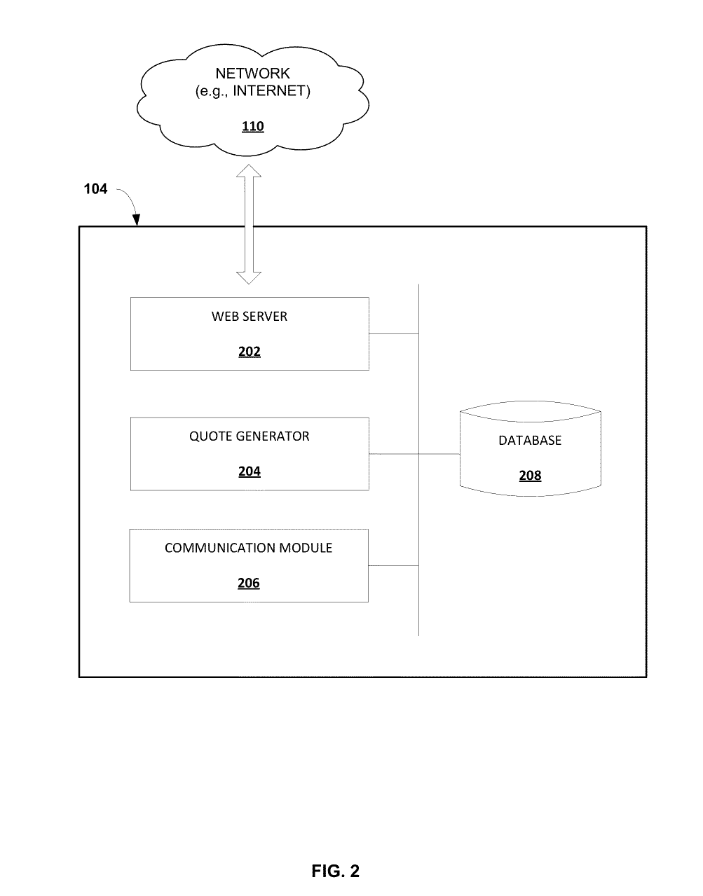

The quoting system 104, according to various embodiments disclosed herein, may be configured to provide online quoting for multiple services provided by those service providers, which are registered with the system 104. The quoting system 104 may be implemented as a server having multiple modules and databases. The quoting system 104 is described in more detail below with reference to FIG. 2.

According to various embodiments disclosed herein, the one or more affiliated sites 106 may include any website on the Internet, which is related to one of registered service providers. In one example, the affiliated sites 106 have a gateway to the quoting system 104 to enable visitors of these sites to get a price estimate for the services. In yet another example, the affiliated sites 106 have an embedded section in a graphical user interface (GUI) virtually linked to the quoting system 104 to provide functionality for online and instant price quoting of the services provided by the service providers.

The e-mail server 108 may transfer e-mail messages from one computer to another computer, using client-server or cloud-based application architecture. The e-mail server 108 may be used by one client device 102 to send a message to another client device 102, or may be used by the quoting system 104 to send messages to the client devices 102.

FIG. 2 is a diagram of the quoting system 104 according to an example embodiment. In this embodiment, the quoting system 104 may include a web server 202, a quote generator 204, a communication module 206, and a database 208. In other embodiments, the quoting system 104 may include additional, fewer, or different modules for various applications. Furthermore, all modules may be integrated within a single apparatus, or, alternatively, may be remotely located and optionally be accessed via a third party.

The web server 202 may connect the quoting system 104 to the one or more client devices 102, the one or more affiliated sites 106, and the one or more e-mail servers 108 via the network 110. The connection and data transfer may be provided via an Application Programming Interface (API).

The web server 202 may be implemented as hardware having software installed thereon that implements the steps to operate the quoting system according to various embodiments disclosed herein. The web server 202 may also host a quoting site 116 directed to provide, among other things, instant online quotes to the services responsive to the user input and predetermined parameters of the selected service providers, to provide access to the database 208 to review service information, service providers, and the like as to provide functionality for negotiating between users and service providers, between users, and between service providers.

According to various embodiments, the service providers may first register with the quoting site 116 and create a member profile. If this is the case, the membership details may be stored in the database 208. The membership profile stored in the database 208 may store service provider information, such as a name, a business name, a nickname, user credentials, a representative picture/photo/logo, an address, a phone number, a fax number, an e-mail address, a web address, or any other form of contact and personal information. The member profile may also include commercial and related information, such as description of services or products that may be provided to users, prices for the services, turnaround times, quoting algorithms, discount algorithms, and other digital content, such as text, images, video, audio, and so forth. In one example, the service providers may store questionnaires that may be used by users to get instant quote for the services.

The service providers may also manage their profiles (personal webpages within the quoting site 116) in the database 208. In addition, the quoting site 116 may manually or automatically access the one or more affiliated sites 106. The quoting site 116 may also enable communications with other service providers or users and sharing information including resources. According to another example, the quoting site 116 may allow the service providers to share information via the one or more affiliated sites 106.

Pursuant to the example embodiment, the quote generator 204 may be configured to process user requests to get quotes for services. Specifically, responsive to the user request, the quote generator 204 may intelligently select one or more service providers able to perform the services, and calculate price quotes for the services based on the predetermined parameters stipulated by the selected service providers. The predetermined parameters may include, among other things, a list of available services, pricing details, price calculating algorithms, discount algorithms, service package details, and estimated turnaround times to perform the services. In one example, when the user request for a price quote is received, the quote generator 204 may retrieve predetermined parameters from the database 208, and calculate the price quote.

The communication module 206 may be configured to receive user requests for price quotes. In one exemplary embodiment, user requests are received via the web server 202, or, alternatively, via one or more APIs from any affiliated websites 106. The communication module 206 may also be configured to deliver the result of calculating of the quote performed by the quote generator 204 to one or more of corresponding users. The communication module 206 may be configured to provide functionality to negotiate between users and service providers, and provide access to the database 208 for making posts, storing reviews, rankings, establish and manage service providers' profiles, and so forth.

The database 208 may store membership related information, such as service providers profiles, and service providers predetermined parameters, which include lists of available services, pricing details, price calculating algorithms, discount algorithms, service package details, turnaround times to perform the services, and other information. The service providers may access the database 208 via the web server 202 and/or communication module 206 to review, modify or delete information stored therein. The prospect users may access the database 208 for reviewing stored information, and to add additional comments, negotiate, assign ranks, and so forth.

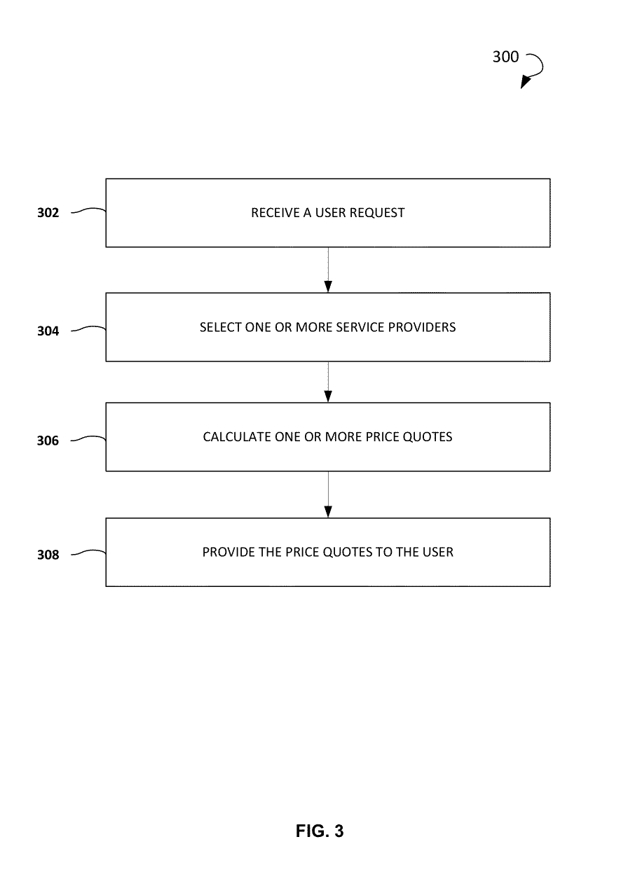

FIG. 3 is a process flow diagram showing a method 300 for providing a price quote according to an example embodiment.

The method 300 may be performed by a processing logic that may include hardware (e.g., dedicated logic, programmable logic, and microcode), software (such as software run on a general-purpose computer system or a dedicated machine), or a combination of both. In one example embodiment, the processing logic resides at the quoting system 104.

The method 300 may be performed by the various modules discussed above with reference to FIG. 2. Each of these modules may include processing logic. It will be appreciated by one of ordinary skill that examples of the foregoing modules may be virtual, and instructions said to be executed by a module may, in fact, be retrieved and executed by a processor. The foregoing modules may also include memory cards, servers, and/or computer discs. Although various modules may be configured to perform some or all of various steps described herein, fewer or more modules may be provided and still fall within the scope of various embodiments.

As shown in FIG. 3, the method 300 may commence at operation 302 with the quoting system 104 receiving a user request to provide a price quote for certain services. In one example, the user may visit the quoting site 116 or any affiliated site 106 via the browser 112 with the purpose of getting price quotes for a service, and optionally to order such service or contact certain service providers. In one other embodiment, the user may send the user request via the software 114 embedded in the client device 102. In the shown example, the user request may include a service and optionally specific details of the services.

At the next operation 304, the quoting system 104 processes the user request and access the database 208 to select one or more service providers enable to provide the service as stated in the user request. At operation 306, the quote generator 204 of the quoting system 104 calculates one or more price quotes based on the predetermined parameters. The price quote may include one or more of service provider details, service details, pricing details, turnaround time, and locations of the selected server providers.

At operation 308, the calculated price quotes are provided to the users. The price quotes may be displayed on the client devices 102 via the browser 112 or software 114.

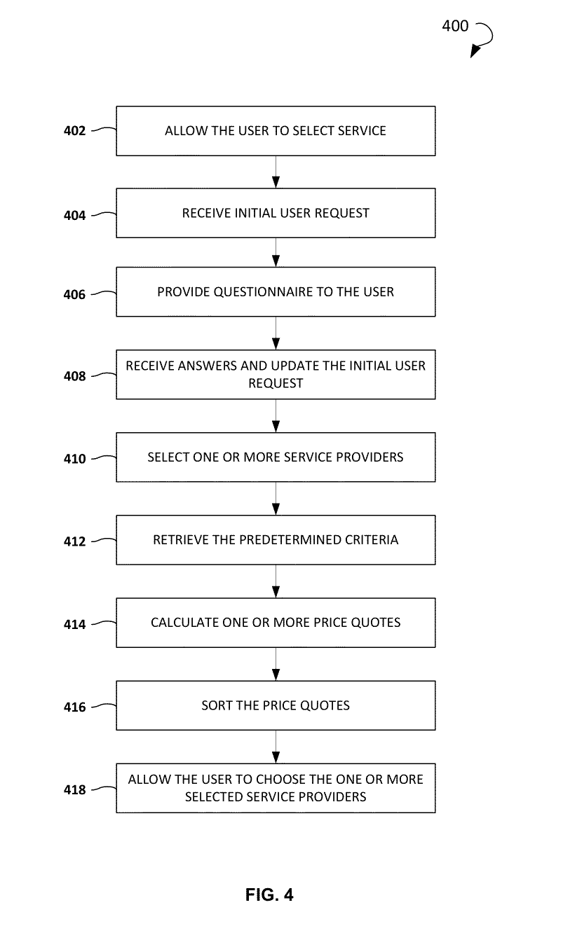

FIG. 4 is a process flow diagram showing a method 400 for providing a price quote according to another example embodiment. The method 400 may be performed by processing logic that may include hardware (e.g., dedicated logic, programmable logic, and microcode), software (such as software run on a general-purpose computer system or a dedicated machine), or a combination of both. In one example embodiment, the processing logic resides at the quoting system 104.

The method 400 may be performed by the various modules discussed above with reference to FIG. 2. Each of these modules may include processing logic. It will be appreciated by one of ordinary skill that examples of the foregoing modules may be virtual, and instructions said to be executed by a module may, in fact, be retrieved and executed by a processor. The foregoing modules may also include memory cards, servers, and/or computer discs. Although various modules may be configured to perform some or all of the various steps described herein, fewer or more modules may be provided and still fall within the scope of various embodiments.

The method 400 may commence at operation 402 with the quoting system 104 allowing the user to select one or more of services to get a price quote. The user selection may optionally include parameters of the services. The user selection represents an initial user request.

At operation 404, the initial user request to provide the price quote for certain services is received by the quoting system 104. At the next operation 406, the quoting system 104 provides the user with a questionnaire related to the services stated in the initial user request. The questionnaire may include one or more questions related to the services. For example, if the initial user request indicates that the user needs to repair a computer, the questionnaire may provide the user with questions to identify existing problem (troubleshooting procedure). In yet another example, the user may be in need of wedding photographer services. The questionnaire may include such questions as a number of hours, a number of photos, whether a video is to be prepared, whether an album is to be printed, and so forth. Furthermore, the users may be requested to input their location (e.g., a zip code). In one example, the questionnaire may be preset for each service category. In yet another example, the questionnaire may be preset by service providers.

The questionnaires may be stored in the database 208 and may be retrieved upon a request of the user. Accordingly, the user may be provided with standardized questionnaires, or with questionnaires preset by certain service providers, if the initial user request includes an indication as to service providers.

At operation 408, the user is allowed to provide answers (or selections) to the questions of the provided questionnaire, and these answers are then received by the quoting system 104 (via the web server 202 or the communication module 206). The initial user request may optionally be updated based on the user answers.

At operation 410, the quoting system 104 selects one or more service providers, which may serve the user and provide the services. The selection may be made based on the analysis of the user request and the answers to the questionnaire, and comparison of the provided answers with the predetermined parameters of the service providers stored in the database 208.

At operation 412, the quoting system 104 retrieves the predetermined parameters of the selected service providers. The predetermined parameters of the service providers may include a list of available services, pricing details, price calculating algorithms, discount algorithms, service package details, estimated turnaround times to perform the services, and the like.

At operation 414, the quoting system 104, and in particular, the quote generator 204, calculates one or more price quotes for the services based on the predetermined parameters of the selected service providers, and based on the user request. Specifically, predetermined calculating algorithms and discount algorithms may be applied to the services and their particulars. For the example provided above, a calculating algorithm may be applied to the inputted number of photos, the approximate number of hours it will take to take the photos, whether an album needs to be printed, and the like. If the number of photos is more than a predetermined value, percentage discount algorithms may be applied to the total price paid for the services. Those skilled in the art would appreciate that any calculating and discount algorithms may be applied to the user request.

According to various embodiments disclosed herein, the price quote may include one or more of service provider details, service details, pricing details, turnaround time, the location of the server provider, the rank of the service provider, and so forth.

At operation 416, the price quotes of multiple service providers are optionally sorted. The sorting may be based on geographical proximity of the selected service providers to the user, a rank of the service providers, estimated turnaround time, a price range, service provider membership details or bids (e.g., paid membership or certain bids may cause the service providers to be listed before service providers with free membership).

The geographical proximity may be determined based on determination of the geographical location of the client device 102 based on the information sent by a GPS receiver. Alternatively, the geographical location may be determined by the IP address associated with the client device 102 or the location of a base stations, and the like. It should be apparent for those skilled in the art that numerous methodologies may be applied to determine the user location.

The price quotes or service providers may also be filtered from the list generated at the operation 414. The filtering may optionally be based on predetermined settings, which may include a service type, geographical proximity of the selected service providers, a rank, reviews, estimated turnaround time, a price range, and service provider membership details.

At operation 418, the user is allowed to choose one or more of the previously listed service providers for ordering services or negotiating. In one example embodiment, the user may order and pay for the services proposed by the service providers via the quoting system 104.

According to various embodiments, the user may also post a review of the ordered services or service providers based on their experience. In addition, the user may assign ranks to the services or service providers. The ranks and reviews may be stored in the database 208 for further reviewing by other users.

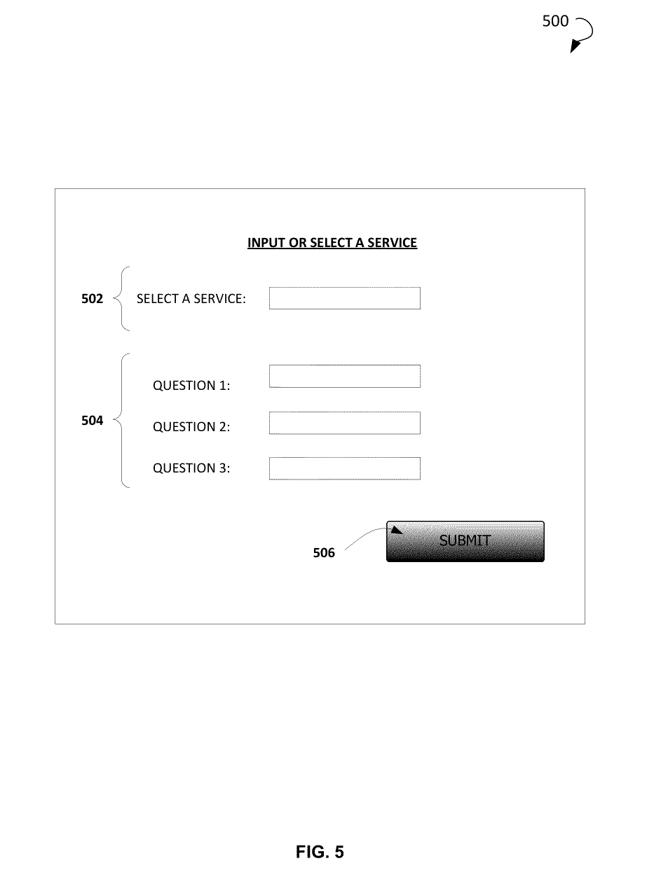

FIG. 5 illustrates a graphical user interface 500 for making the user request for any service according to an example embodiment. The graphical user interface may be represented as a window (e.g., a browser window) to allow input or selection of services. The user interface 500 may include one or more of input sections. A section 502 is designed to receive input or selection of a service (e.g., the user may select “computer repair” or “wedding photographer”). A section 504 is optional, and is designed to receive input or selection of answers to one or more preset questions (e.g., the user may input the number of photos, the number of hours, a location of the user (zip code), and the like).

The user interface 500 may also include an actionable button 506 to submit inputted parameters to the quoting system 104 and to store them in the database 208. In other embodiments, the graphical user interface 500 may include additional, fewer, or different modules for various applications.

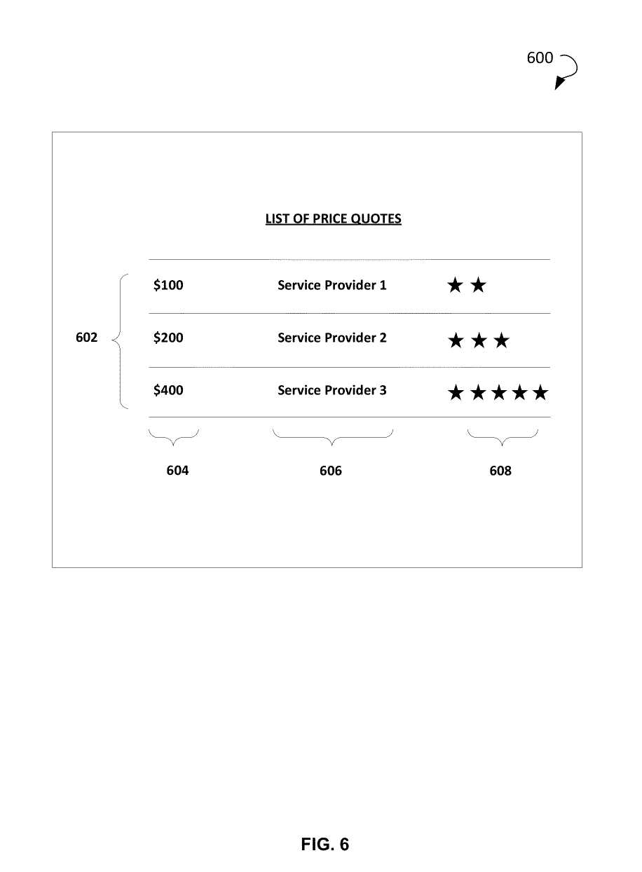

FIG. 6 illustrates a graphical user interface 600 showing a generated list of price quotes responsive to the user request according to an example embodiment. The graphical user interface 600 may be represented as a window, e.g., a browser window. The user interface 600 may include a section 602 showing a list of the price quotes, which is generated by the method disclosed with reference to FIG. 3 and FIG. 4. The list may include a single price quote or multiple of them. The results in the list may be sorted and/or filtered. In the shown example, the results are incrementally sorted by the price calculated by the quoting system 104.

The list of quotes includes several sections, which may be as follows: a section 604 represents the calculated price for the service, a section 606 represents a service provider name, logo, and type description (may include more or less information), a section 608 represents a rank assigned to the listed service providers. In other embodiments, the graphical user interface 600 may include additional, fewer, or different modules for various applications.

In some example embodiments, the result of price quoting may be mapped to a geographical map with flags to indicate the location of selected service providers, the calculated price, ranks, and so forth.

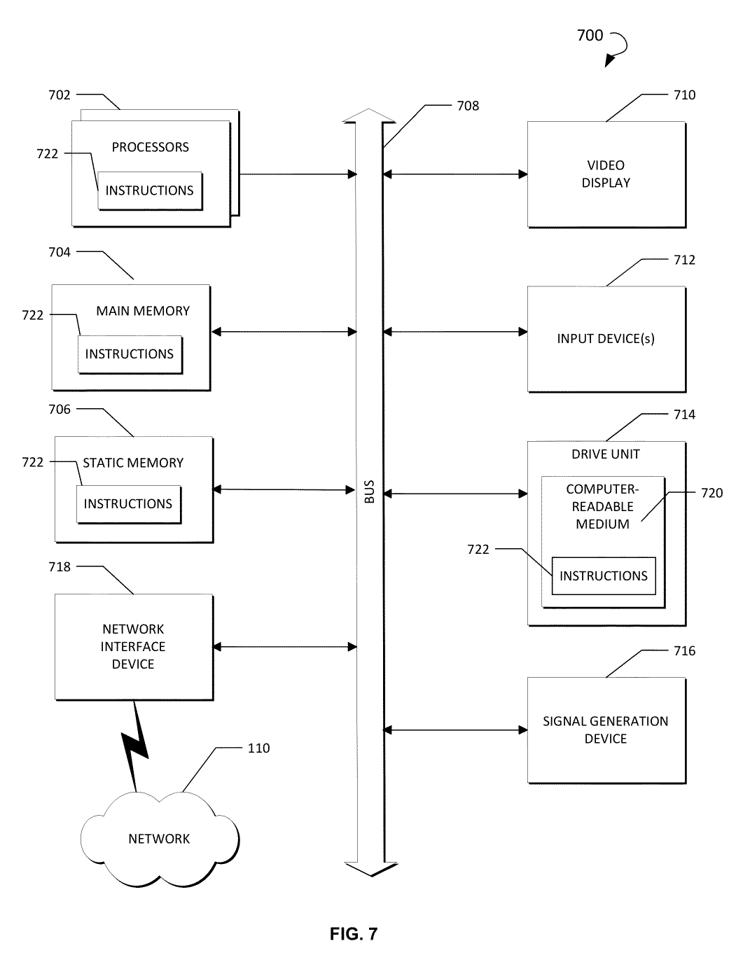

FIG. 7 shows a diagrammatic representation of a computing device for a machine in the example electronic form of a computer system 700, within which a set of instructions for causing the machine to perform any one or more of the methodologies discussed herein may be executed. In various example embodiments, the machine operates as a standalone device or may be connected (e.g., networked) to other machines. In a networked deployment, the machine may operate in the capacity of a server or a client machine in a server-client network environment, or as a peer machine in a peer-to-peer (or distributed) network environment. The machine may be a personal computer (PC), a tablet PC, a set-top box (STB), a PDA, a cellular telephone, a portable music player (e.g., a portable hard drive audio device, such as an Moving Picture Experts Group Audio Layer 3 (MP3) player), a web appliance, a network router, a switch, a bridge, or any machine capable of executing a set of instructions (sequential or otherwise) that specify actions to be taken by that machine. Further, while only a single machine is illustrated, the term “machine” shall also be taken to include any collection of machines that individually or jointly execute a set (or multiple sets) of instructions to perform any one or more of the methodologies discussed herein.

The example computer system 700 includes a processor or multiple processors 702 (e.g., a central processing unit (CPU), a graphics processing unit (GPU), or both), and a main memory 704 and a static memory 706, which communicate with each other via a bus 708. The computer system 700 may further include a video display unit 710 (e.g., a liquid crystal displays (LCD) or a cathode ray tube (CRT)). The computer system 700 also includes at least one input device 712, such as an alphanumeric input device (e.g., a keyboard), a cursor control device (e.g., a mouse), a microphone, and so forth. The computer system 700 also includes a disk drive unit 714, a signal generation device 716 (e.g., a speaker), and a network interface device 718.

The disk drive unit 714 includes a computer-readable medium 720, which stores one or more sets of instructions and data structures (e.g., instructions 722) embodying or utilized by any one or more of the methodologies or functions described herein. The instructions 722 may also reside, completely or at least partially, within the main memory 704 and/or within the processors 702 during execution thereof by the computer system 700. The main memory 704 and the processors 702 also constitute machine-readable media.

The instructions 722 may further be transmitted or received over the network 110 via the network interface device 718 utilizing any one of a number of well-known transfer protocols (e.g., Hyper Text Transfer Protocol (HTTP), MAY, Serial, and Modbus).

While the computer-readable medium 720 is shown in an example embodiment to be a single medium, the term “computer-readable medium” should be taken to include a single medium or multiple media (e.g., a centralized or distributed database, and/or associated caches and servers) that store the one or more sets of instructions. The term “computer-readable medium” shall also be taken to include any medium that is capable of storing, encoding, or carrying a set of instructions for execution by the machine and that causes the machine to perform any one or more of the methodologies of the present application, or that is capable of storing, encoding, or carrying data structures utilized by or associated with such a set of instructions. The term “computer-readable medium” shall accordingly be taken to include, but not be limited to, solid-state memories, optical and magnetic media. Such media may also include, without limitation, hard disks, floppy disks, flash memory cards, digital video disks, random access memory (RAMs), read only memory (ROMs), and the like.

The example embodiments described herein may be implemented in an operating environment comprising computer-executable instructions (e.g., software) installed on a computer, in hardware, or in a combination of software and hardware. The computer-executable instructions may be written in a computer programming language or may be embodied in firmware logic. If written in a programming language conforming to a recognized standard, such instructions may be executed on a variety of hardware platforms and for interfaces to a variety of operating systems. Although not limited thereto, computer software programs for implementing the present method may be written in any number of suitable programming languages such as, for example, Hypertext Markup Language (HTML), Dynamic HTML, Extensible Markup Language (XML), Extensible Stylesheet Language (XSL), Document Style Semantics and Specification Language (DSSSL), Cascading Style Sheets (CSS), Synchronized Multimedia Integration Language (SMIL), Wireless Markup Language (WML), Java™, Jini™, C, C++, Perl, UNIX Shell, Visual Basic or Visual Basic Script, Virtual Reality Markup Language (VRML), ColdFusion™ or other compilers, assemblers, interpreters or other computer languages or platforms.

Thus, methods and systems for online price quoting are provided. The methods and systems allow getting instant estimates of a price, turnaround time, and other information related to any services in a quick and convenient way. The estimation is performed automatically based on the user input and the predetermined settings of the registered service providers and delivered via a network, such as the Internet.

Although embodiments have been described with reference to specific example embodiments, it will be evident that various modifications and changes may be made to these example embodiments without departing from the broader spirit and scope of the present application. Accordingly, the specification and drawings are to be regarded in an illustrative rather than a restrictive sense.

What is claimed is:

1. A computer-implemented method for providing one or more price quotes, the method comprising:
receiving, from a user, a user request for the one or more price quotes, the user request being associated with one or more services;
selecting, based on the user request, one or more service providers associated with the one or more services;
calculating, based on predetermined parameters of the one or more service providers, the one or more price quotes are associated with the one or more services; and
providing the one or more price quotes to the user.

2. The computer-implemented method of claim 1, wherein the user request includes user data including one or more of the following: personal data of the user, user-specified data, a geographical location of the user, a questionnaire.

3. The computer-implemented method of claim 2, wherein the selection includes processing the user data based on the predetermined parameters of the one or more service providers.

4. The computer-implemented method of claim 1, wherein the selection includes:
analyzing a geographical location of the one or more service providers based on a geographical location of the user; and
determining, based on the analysis, the one or more service providers located within a predetermined distance from the geographical location of the user.

5. The computer-implemented method of claim 1, further comprising filtering the selection based on predetermined settings, the predetermined settings including one or more of the following: a service type, a geographical proximity of the selected service providers, a rank, one or more reviews, an estimated turnaround time, a price range, and membership details of the one or more service providers.

6. The computer-implemented method of claim 1, wherein the one or more price quotes include one or more of the following: details of the one or more service providers, service details, pricing details, a turnaround time, a geographical location of the one or more service providers.

7. The computer-implemented method of claim 1, wherein the predetermined parameters of the one or more service providers include a list of available services, pricing details, price calculating algorithms, discount algorithms, service package details, and estimated turnaround times.

8. The computer-implemented method of claim 1, wherein the calculation includes applying one or more discount algorithms of the service providers, wherein the discount algorithms include selectively applying a percentage discount based on the user request.

9. The computer-implemented method of claim 1, further comprising:
receiving a user selection associated with the one or more service providers; and
sending a one or more service orders to the one or more service providers associated with the user selection.

10. The computer-implemented method of claim 9, further comprising:
receiving a user review of one or more services or the one or more service providers based on experience of the user; and
receiving a user rank to the one or more services or the one or more service providers based on the experience of the user.

11. A computer-implemented system for providing a price quote, the system comprising:
at least one processor configured to:
receive, from a user, a user request for the one or more price quotes, the user request being associated with one or more services;
select, based on the user request, one or more service providers associated with the one or more services;
calculate, based on predetermined parameters of the one or more service providers, the one or more price quotes associated with the one or more services; and
provide the one or more price quotes to a user;
a memory coupled to the at least one processor, the memory including computer codes for the at least one processor.

12. The computer-implemented system of claim 11, wherein the user request includes user data including one or more of the following: personal data of the user, user-specified data, a geographical location of the user, a questionnaire.

13. The computer-implemented system of claim 11, wherein the selection includes processing the user data based on the predetermined parameters of the one or more service providers.

14. The computer-implemented system of claim 11, wherein the selection includes:
analyzing a geographical location of the one or more service providers based on a geographical location of the user; and
determining, based on the analysis, the one or more service providers located within a predetermined distance from the geographical location of the user.

15. The computer-implemented system of claim 11, further comprising filtering the selection based on predetermined settings, the predetermined settings including one or more of the following: a service type, a geographical proximity of the selected service providers, a rank, one or more reviews, an estimated turnaround time, a price range, and membership details of the one or more service providers.

16. The computer-implemented system of claim 11, wherein the one or more price quotes include one or more of the following: details of the one or more service providers, service details, pricing details, a turnaround time, a geographical location of the one or more service providers.

17. The computer-implemented system of claim 11, wherein the predetermined parameters of the one or more service providers include a list of available services, pricing details, price calculating algorithms, discount algorithms, service package details, and estimated turnaround times.

18. The computer-implemented system of claim 11, wherein the calculation includes applying one or more discount algorithms of the service providers, wherein the discount algorithms include selectively applying a percentage discount based on the user request.

19. The computer-implemented system of claim 11, further comprising:
receiving a user selection associated with the one or more service providers; and
sending a one or more service orders to the one or more service providers associated with the user selection.

20. A computer-readable medium having instructions stored thereon, which when executed by one or more computers, causes the one or more computers to:
receive, from a user, a user request for the one or more price quotes, the user request being associated with one or more services;
select, based on the user request, one or more service providers associated with the one or more services;
calculate, based on predetermined parameters of the one or more service providers, the one or more price quotes associated with the one or more services; and
provide the one or more price quotes to a user.
